(19) United States
(12) Patent Application Publication
(10) Pub. No.: US 2025/0192865 A1
(43) Pub. Date: Jun. 12, 2025

(54) MMWAVE CELL DISCOVERY IN ULTRA-DENSE NETWORKS

(71) Applicant: InterDigital Patent Holdings, Inc., Wilmington, DE (US)

(72) Inventors: Steve Ferrante, Doylestown, PA (US); Patrick Tooher, Montreal (CA); Haneya Qureshi, Troy, MI (US); Ananth Kini, Conshohocken, PA (US); Frank LaSita, Long Beach, NY (US); Yugeswar Deenoo Narayanan Thangaraj, Chalfont, PA (US); Benoit Pelletier, Roxboro (CA)

(73) Assignee: InterDigital Patent Holdings, Inc., Wilmington, DE (US)

(21) Appl. No.: 18/838,894

(22) PCT Filed: Feb. 28, 2023
(86) PCT No.: PCT/US2023/014136

§ 371 Date: Aug. 15, 2024

Related U.S. Application Data
(60) Provisional application No. 63/314,782, filed on Feb. 28, 2022.
(60) Provisional application No. 63/421,456, filed on Nov. 1, 2022.

(51) Int. Cl. H04B 7/06; H04W 8/00

(52) U.S. Cl. CPC H04B 7/0696; H04B 7/06958; H04W 8/005

(57) ABSTRACT

A wireless transmit/receive unit (WTRU) may perform cell selection and/or beam association as described herein. The WTRU may use contextual information, such as a location, to enable cell selection and/or beam association. The WTRU may be configured with a resource on which to report WTRU contextual information. The WTRU may receive, in response to the contextual information, assistance information associated with one or more cells for enabling cell selection and/or beam association. For example, the WTRU may receive a defined subset of measurement resources in response to the transmission of the location on the resource. The WTRU may determine a base station (BS) and/or a beam pair (BP) based on the assistance information. The WTRU may perform a transmission to the BS using at least one beam of the BP.

### CROSS-REFERENCE TO RELATED APPLICATION

This application claims priority to U.S. Provisional Patent Application No. 63/314,782 filed in the United States of America on Feb. 28, 2022, and to U.S. Provisional Patent Application No. 63/421,456 filed in the United States of America on Nov. 1, 2022, the entire contents of each of which are incorporated herein by reference.

### BACKGROUND

Millimeter wave (mmWave) cell discovery in emerging mobile networks may have relatively high signal directivity. Exhaustive periodic beam sweeping (e.g., which may have relatively high latency) may be used. Hierarchical beam sweeping may be used to reduce latency. Additionally and/or alternatively, artificial intelligence (AI) may be used to reduce latency.

Frequency spectrum in the mmWave range may be used in emerging networks to address the capacity crunch problem faced by existing networks. However, mmWave may have a relatively short coverage range due to path loss occurring at mmWave frequencies. To compensate for this, mmWave systems may rely on directional antennas, which may make cell discovery more difficult compared to using more traditional omnidirectional antennas. Moreover, mmWave signals may be highly sensitive to environmental variations that result in blockages. For these reasons, successful mmWave base station (BS) discovery may rely on proper beam alignment between a wireless transmit/receive unit (WTRU) and mmWave BS, which refers to the process of finding the best beamforming direction between the WTRU and the BS for transmission and reception during initial access to establish a mmWave link before data can be sent.

### SUMMARY

A wireless transmit/receive unit (WTRU) may perform cell selection and/or beam association as described herein. The WTRU may perform cell reselection and/or beam association in one or more phases. For example, the WTRU may perform cell reselection and/or beam association using a two-phase procedure as described herein. The WTRU may use contextual information, such as the WTRU's location, to enable the first phase of cell selection and/or beam association. The WTRU may refine the cell selection and/or beam association during a second phase of a procedure.

Systems, methods and apparatus are described herein for performing cell selection and/or beam association. In an example, a WTRU may receive system information for one or more cells (e.g., set of cells). The WTRU may be configured (e.g., via System Information (SI), Radio Resource Control (RRC), Medium Access Control (MAC) Control Element (CE) and/or Downlink Control Information (DCI) with a resource on which to report WTRU contextual information, such as the WTRU's location. The resource may be indicated in the system information. Additionally or alternatively, the resource may be configured by RRC (e.g., to enable mobility to a different cell). The WTRU may be configured to determine and/or report the contextual information. The WTRU may transmit the determined contextual information (e.g., on the resource). The WTRU may receive a defined subset of measurement resources associated with one or more cells for enabling cell selection and/or beam association based on the contextual information. For example, the WTRU may receive a defined subset of measurement resources in response to the transmission of the location on the resource. The WTRU may determine a cell of a base station (BS) and/or a beam pair (BP) based on measurements performed on the defined subset of measurement resources. The WTRU may perform a first transmission to the BS using one or more of the beams (e.g., an uplink (UL)) of the BP.

The WTRU may be configured to improve beam-pairing quality. The WTRU may be able to determine and/or indicate if fine-tuning is enabled (e.g., as a function of WTRU service requirements). In an example, a WTRU may report one or more first measurements and/or may report one or more service requirements. For example, the WTRU may report the one or more first measurements to the BS (e.g., via one or more of the beams of the BP). For example, the WTRU may report one or more service requirements to the BS (e.g., via one or more of the beams of the first BP). The WTRU may receive a second defined subset of measurement resources associated with the BS (e.g., in response to the one or more first measurements and/or the service requirements). The WTRU may determine a second BP having a beam width that is narrower than the beam width of the first BP (e.g., based on second measurements performed on the second defined subset of measurement resources). The WTRU may perform a second transmission to the BS using one or more of the beams (e.g., an UL transmit) of the second BP.

Hierarchical low latency low power initial access may be used. One or more coverage quality indicators (e.g., reference signal received power (RSRP) and/or a location of a WTRU) that are acquired (e.g., via Minimization of Drive Test (MDT) traces) may be used by an AI. The first of two or more phases may use an AI technique to predict WTRU-base station (BS) association with relatively wide beams. The first phase may provide a single wide beam and/or an ordered list of candidates to the remaining phases. The remaining phases may use a different technique (e.g., conventional beam sweeping) to sort through candidates and/or transition to narrower beams if user demand requires.

A WTRU may report its location to enable AI-based cell detection. For example, the WTRU may perform one or more methods, receive one or more resources, and/or receive one or more triggers to report its location. The WTRU may perform AI-based cell detection as a function of measurements and/or broadcasted information. The WTRU may receive a configuration for a cell/beam prior to accessing the cell. The WTRU may use a DL beam pair for a UL transmission. The WTRU may report a preferred cell, beam, and/or beam pair.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 1E is a schematic illustration of an example system environment for training and applying an artificial intelligence (AI)/machine learning (ML) model.

FIG. 2 illustrates an example network topology showing base station (BS) locations, array orientations, sweeping directions, and a sample WTRU distribution.

FIG. 3 illustrates example simulation parameters.

FIG. 4 illustrates an example process that may be implemented for performing cell selection and/or beam association using AI/ML.

FIG. 5 illustrates example correct and incorrect predictions using a k-nearest neighbor (KNN) algorithm.

FIG. 6 illustrates an example deep neural network (DNN) architecture, where rectified linear unit (ReLU) activation may be used for layers dense_1 and dense_2, output layers may have sigmoid activation, the loss function used may be a sparse categorical entropy function, and the optimizer may be an Adam optimization function.

FIG. 7 illustrates example average accuracies of ML algorithms.

FIG. 8 illustrates example receiver operating characteristics (ROCs) for KNN classifiers for one or more classes.

FIG. 9 illustrates an example impact of ML-based predictions in terms of RSRP.

FIG. 10A illustrates a system flow diagram depicting an example of a communication procedure for determining a configuration for a cell selection and/or beam association (e.g., beam-pair).

FIG. 10B illustrates a system flow diagram depicting an example of a communication procedure for improving the configuration for a cell selection and/or beam association (e.g., beam-pair).

### DETAILED DESCRIPTION

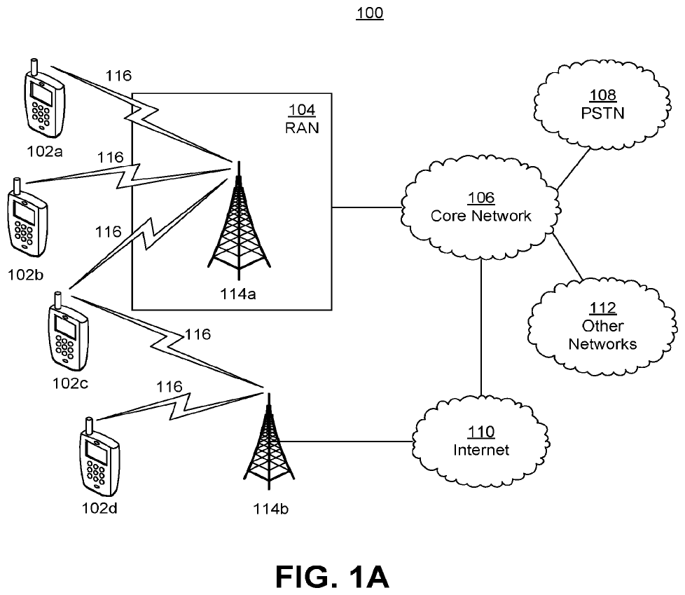

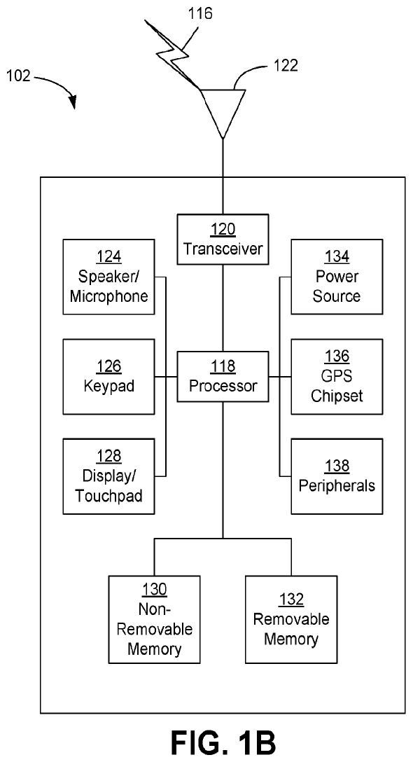

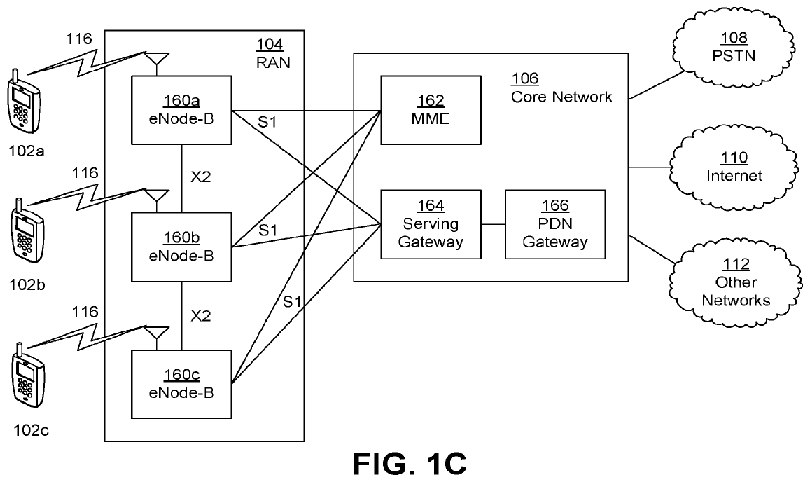

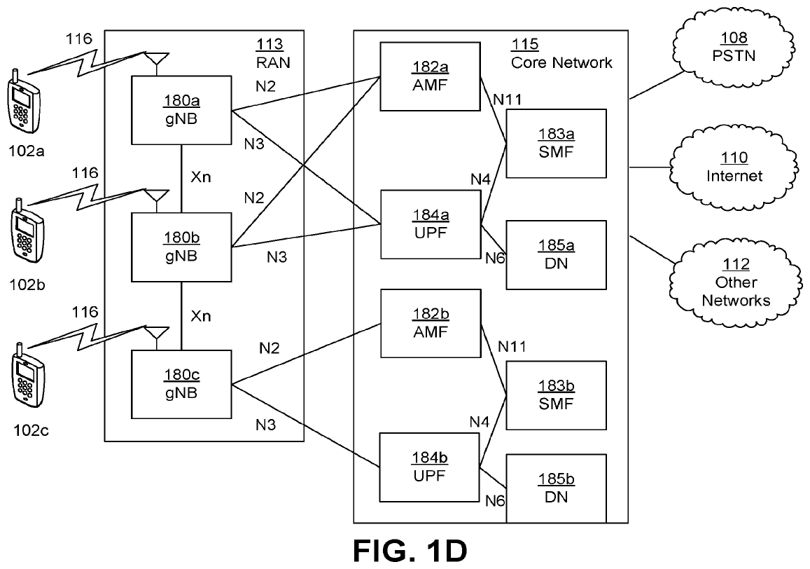

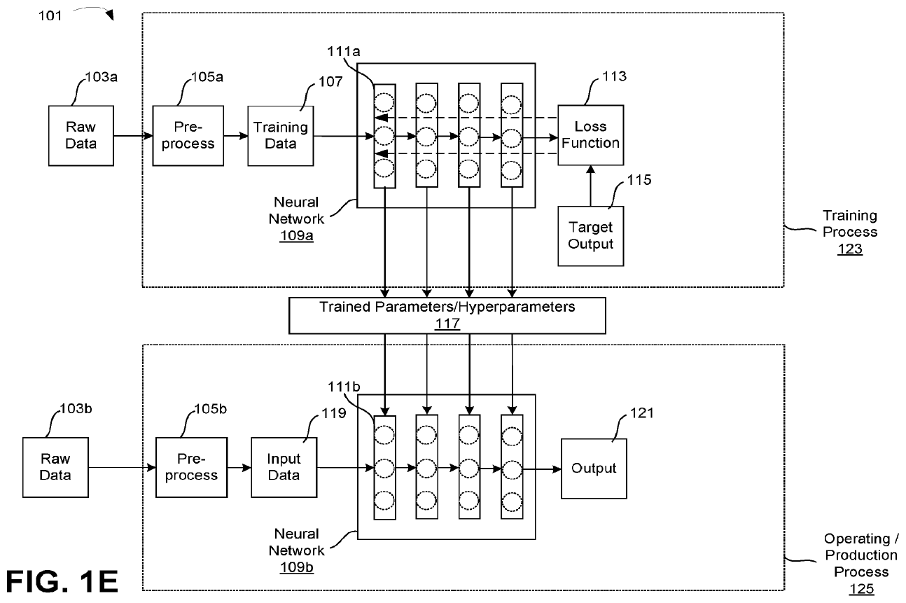

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHZ channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and/or apparatus described herein may implement artificial intelligence (AI) and/or machine learning (ML). For example, one or more devices in the communication system 100 may implement AI/ML. One or more of the WTRUs 102a, 102b, 102c, 102d, the RAN 104/113, and/or the CN 106/115 may implement AI/ML. Additionally, other WTRUs, base stations and/or network elements may implement AI/ML.

The AI/ML may implement one or more algorithms configured to learn from data that is received as input. The AI/ML may implement supervised or unsupervised learning. When implementing supervised learning, the AI/ML may receive training data as input and parameters of the AI/ML may be trained toward a particular target output. The training data may be labeled to teach the AI/ML to learn from the labeled data and to test the accuracy of the AI/ML for being implemented on unlabeled input data during production. Supervised learning may be implemented for various types of AI/ML algorithms, including algorithms that implement linear regression, logistic regression, neural networks, decision trees, Bayesian logic, random forests, and/or support vector machines (SVMs). Supervised learning may be regularly utilized for and/or may be implemented for classification algorithms and/or regression algorithms. Classification algorithms may be used to categorize data into a class and/or category. Example classification algorithms may include logistics regression algorithms, Naïve Bayes algorithms, k-nearest neighbors (KNN) algorithms, decision tree algorithms, and/or support vector machines. Regression algorithms may include linear regression algorithms, ridge regression algorithms, neural network regression algorithms, decision tree regression algorithms, random forest algorithms, KNN regression models, support vector machines (SVM), Gaussian regression algorithms, and/or polynomial regression algorithms.

AI/ML may implement deep learning-based models. Neural networks (NNs) and/or Deep neural networks (DNNs) may be popular examples of AI/ML models that may be trained using supervised training. Various examples of NNs include: perceptrons, multilayer perceptrons (MLPs), feed forward NNs, fully-connected NNs, convolutional Neural Networks (CNNs), recurrent NNs (RNNs), long-short term memory (LSTM) NNs, and/or residual NNs (ResNets). A perceptron is a NN that includes a function that multiplies its input by a learned weight coefficient to generate an output value. A feed forward NN is a NN that receives input at one or more nodes of an input layer and moves information in a direction through one or more hidden layers to one or more nodes of an output layer. In a feed forward NN, one or more nodes of a given layer may be connected to one or more nodes of another layer. A fully connected NN is a NN that includes an input layer, one or more hidden layers, and an output layer. In a fully connected NN, each node in a layer is connected to each node in another layer of the NN. An MLP is a fully connected class of feed forward NNs. A CNN is a NN having one or more convolutional layers configured to perform a convolution. Various types of NNs may have elements that include one or more CNNs or convolutional layers, such as Generative Adversarial Networks (GANs), Conditional Generative Adversarial Networks (CGANs), and/or cycle-consistent Generative Adversarial Networks (CycleGANs). An RNN is a NN that is recurrent in nature, as the nodes include feedback connections and an internal hidden state (e.g., memory) that allows output from nodes in the NN to affect subsequent input to the same nodes. LSTM NNs may be similar to RNNs in that the nodes have feedback connections and an internal hidden state (e.g., memory). However, the LSTM NNs may include additional gates to allow the LSTM NNs to learn longer-term dependencies between sequences of data. A ResNet is a NN that may include skip connections to skip one or more layers of the NN.

FIG. 1E is a schematic illustration of an example system environment 101 for training and applying an AI/ML model that implements an NN 109a. However, other types of AI/ML models may be similarly trained and/or implemented. The NN 109a may be trained to determine and/or update parameters (e.g., hyperparameters) of the NN 109a. Raw data 103a may be generated from one or more sources. For example, the raw data 103a may include image data, a sequence of information, such as a sequence of text or a sequence of network information related to a communication network, and/or other types of data. The raw data 103a may be preprocessed at 105a to generate training data 107. The preprocessing may include formatting changes or other types of processing in order to generate the training data 107 in a format for being input into the NN 109a.

The NN 109a may include one or more layers 111a. The one or more layers 111a may include one or more input layers for receiving the training data 107, one or more hidden layers, and/or one or more output layers for generating an output 121. Each layer 111a may include one or more nodes capable of being trained, as described herein. The training data 107 may be in one or more formats, such as an image format, a tensor format (e.g., including multi-dimensional arrays), and/or the like.

During the training process 123, the training data 107 may be input into the NN 109a and may be used to learn parameters. The parameters may include weights and/or biases of the NN 109a. The NN 109a may also include hyperparameters. The hyperparameters may include a number of epochs, a batch size, a number of layers, and/or a number of nodes in each layer, for example. Some may use parameters and hyperparameters interchangeably. The parameters and/or hyperparameters may be tuned during the training process. The training may be performed by initializing parameters and/or hyperparameters of the NN 109a, accessing the training data 107, generating inputting the training data 107 into the NN 109a, calculating the loss from the output of the neural network 109a to a target output 115 via a loss function 113 to update the parameters and/or hyperparameters (e.g., via gradient descent and associated back propagation), updating the parameters and/or hyperparameters, and/iterating the training process until an end condition is achieved. The end condition may be achieved when the output of the neural network 109a is within a predefined threshold of the target output 115.

The loss function 113 may be implemented using backpropagation-based gradient updates and/or gradient descent techniques, such as Stochastic Gradient Descent (SGD), synchronous SGD, asynchronous SGD, batch gradient descent, and/or mini-batch gradient descent. An optimizer may be implemented along with the loss function 113. The optimizer may be implemented to update the parameters and/or hyperparameters of the neural network 109a.

After the training process 123 is complete, the trained parameters and/or hyperparameters 117 may be implemented by a neural network 109b in an operating or production process 125. During the operating or production process 125, the neural network 109b may receive input data 119 and use the trained parameters and/or hyperparameters 117 to generate an output 121. The input data 119 may be preprocessed at 105b from raw data 103b. For example, the raw data 103b may include a similar type of data as the raw data 103a, which may be preprocessed similarly to the training data 107 that is used as input during the training process 123. The preprocessing may include formatting changes or other types of processing in order to generate the input data 119 in a format for being input into the NN 109b. The output 121 may be within the predefined threshold of the target output 115 used during the training process 123. The output may 121 be one or more images, tensors, or other format of output. The neural network 109b may include one or more layers 111b having a similar configuration to the layers 111a after the training process 123. During the operating or production process 125 the parameters and/or hyperparameters may be refined or optimized by being updated based on the output 121.

In contrast with supervised learning of AI/ML as described herein, the AI/ML may be used to implement unsupervised learning. The AI/ML may receive training data as input and learn from the data without being trained toward a particular target output. For example, during unsupervised learning the AI/ML may receive unlabeled training data and determine patterns and/or similarities in the training data without being trained toward a particular target output. Unsupervised learning may be implemented for performing clustering, anomaly detection, and/or association of different types of input data. AI/ML may implement hierarchical clustering algorithms, k-means clustering algorithms, anomaly detection algorithms, principal component analysis algorithms, and/or apriori algorithms.

As described herein, the AI/ML may be implemented on one or more devices. For example, the AI/ML may be implemented in whole or in part on one or more devices, such as one or more WTRUs, one or more base stations, and/or one or more other network entities, such as a network server. Examples of network in which AI/ML may be distributed may include federated networks. A federated network may include a decentralized group of devices that each include AI/ML. The AI/ML may be implemented for collaborative learning in which the AI/ML is trained across multiple devices. In another example, the AI/ML may be trained at a centralized location or device and one or more portions of the AI/ML may be distributed to decentralized locations. For example, updated parameters or hyperparameters may be sent to one or more devices for updating the AI/ML implemented thereon. Federated learning enables multiple actors to build a common, robust machine learning model without sharing data, thus allowing to address critical issues such as data privacy, data security, data access rights and/or access to heterogeneous data. Its applications may be spread over a number of industries including defense, telecommunications, IoT, and/or pharmaceutics. A major open question at the moment may be how inferior models learned through federated data are relative to ones where the data are pooled. Another open question may concern the trustworthiness of the edge devices and/or the impact of malicious actors on the learned model.

The AI/ML described herein may be implemented as described herein using software and/or hardware. The AI/ML may be stored as computer-executable instructions on computer-readable media accessible by a processor for performing as described herein. Example AI/ML environments and/or libraries may include TENSORFLOW, TORCH, PYTORCH, MATLAB, GOOGLE CLOUD AI and AUTOML, AMAZON SAGEMAKER, AZURE MACHINE LEARNING STUDIO, and/or ORACLE MACHINE LEARNING.

Cell discovery in millimeter wave (mmWave) networks may include legacy systems (e.g., legacy cell discovery). Legacy systems may include a WTRU performing one or more permutations in order to obtain the information on which the WTRU operates in a given mmWave band. For example, a WTRU may sweep one or more (e.g., a number of) beams/beam-pairs to determine an optimal cell/beam. Contextual-information based techniques/methods may be employed to reduce complexity/latency with respect cell discovery in mmWave networks. Contextual-information based techniques/methods may be based on additional information. For example, contextual information may include a WTRU position and/or location. Contextual-information based techniques may help to reduce the complexity/latency. Hierarchical methods may include a base station (BS) performing an exhaustive search over one or more wide beams. Hierarchical methods may include progressing (e.g., iteratively progressing) to narrower beams.

Systems, methods, and apparatuses are described herein for performing low latency cell discovery (e.g., in a beam-based environment). Systems, methods, and apparatuses may improve beam/cell selection complexity/latency by combining hierarchical search methods with AI/machine learning (ML). Described herein are embodiments for performing cell selection and/or beam association using two phases. The two-phase cell selection/beam association may include acquiring (e.g., via Minimization of Drive Test (MDT) traces) various coverage quality indicators (e.g., reference signal received power (RSRP) and/or WTRU location). The various coverage quality indicators may be used by a BS (e.g., via an AI/ML portion of the two-phase cell selection/beam association). The first phase of the two-phase cell selection/beam association may reduce beam-pairing latency using contextual information. The first phase may provide either a single wide beam and/or an ordered list of candidates to the remaining one or more phases. One or more remaining phases may use a different technique (e.g., beam sweeping) to sort through candidates and/or transition to narrower beams (e.g., in response to user demand).

A WTRU may use its location and/or other contextual information to enable the first phase of a two-phase cell selection/beam association. A WTRU may report its location and/or other contextual information to enable the BS to perform cell detection (e.g., including methods, resources, and/or triggers to report location). Contextual information may include service requirements that can be reported (e.g., reliability requirements, latency requirements, data type, amount of data to transmit, etc.). Reporting may include sending an indication of information indicating the location of the WTRU and/or other contextual information. The indication may be explicit, to explicitly identify the location of the WTRU and/or other contextual information. The indication may implicitly indicate the location of the WTRU and/or other contextual information. The indication may be explicit and/or implicit. A WTRU may receive assistance information from the BS in response to the location information and/or other information to enable configuration for a cell/beam (e.g., prior to accessing the cell). The assistance information may include an indication of a BS (e.g., cell or set of cells) and/or at least one beam of a beam pair (BP). In one example, the assistance information may include a defined subset of measurement resources for one or more cells of the BS and/or at least one beam of the beam pair for enabling cell selection and/or beam association.

The WTRU may update the cell selection and/or beam association. The updated cell selection and/or beam association may be performed in a second phase to allow for refinement of the earlier identified cell/beam pair. For example, the WTRU may update the cell selection/beam association to improve beam-pairing quality as a function of the one or more service requirements of the WTRU. The WTRU may report measurements and/or service requirements to the BS. Reporting may include sending an indication of information indicating the one or more measurements and/or the one or more service requirements. The indication may be explicit, to explicitly indication the one or more measurements and/or the one or more service requirements. The indication may be implicit, to implicitly indicate the one or more measurements and/or the one or more service requirements. The indication may be both explicit and implicit. The WTRU may receive a defined subset of measurement resources for performing cell selection and/or beam association (e.g., in response to the measurements and/or the service requirements). The defined subset of measurement resources may allow the WTRU to determine an updated (e.g., narrower) beam pair in comparison to the original cell/beam pair. Though a two-phase cell selection/beam association procedure may be described herein, cell selection and/or beam association may be implemented in one or more phases. For example, the cell selection/beam association procedure may include the first phase of cell selection/beam association described herein. In another example, one or more portions of the first phase and/or the second phase of the cell selection/beam association procedure may be implemented in a single phase or multiple phases.

There may be one or more techniques described herein that address cell discovery in mmWave networks. The techniques may implement AI/ML using one or more of the following: naïve non-ML techniques (e.g., based on measurements of one or more possible cells and/or beams and/or beam-pairs), ML based techniques, and non-ML techniques utilizing contextual information. The contextual information may include user positions and/or locations, channel gain, user spatial distribution, angle of arrival and departure, past multipath fingerprints, radar signals, sub-6 GHz band information in a control data plane split architecture, and/or antenna configurations. The terms WTRU position and WTRU location may be used interchangeably herein.

One or more naïve non-ML techniques may be used. These techniques may be used to search for an optimal beam pair. For example, a sequential search pattern technique may be used. Sequential search pattern may rely on an exhaustive brute force search through many beam-pair combinations between a WTRU and a base station (BS) to find the optimum beam-pair that has the highest reference signal received power (RSRP). Alternatively, or additionally, a linear rotation pattern may be used. Linear rotation pattern may be an exhaustive search method that sweeps through many beam pairs in either counter-clockwise or clockwise direction. Another technique may be the random starting point method, in which the BS starts the sweeping process by choosing one direction randomly. It then may continue either by using the sequential sweeping method from the randomly selected starting point or by picking randomly from the remaining directions until one or more (e.g., all) directions are swept. Although these techniques may be simple and/or may require (e.g., only) minimum external information, one or more of these techniques may result in long cell discovery times as they sweep in an exhaustive manner, without incorporating any intelligence and/or additional information.

One or more data-driven machine learning (ML) based techniques may be used. These techniques may include one or more approaches that leverage recurrent neural networks (RNNs), in which call detail record (CDR) data may be used to predict the optimal beam pair. In some approaches, pseudo-omni antennas may be used (e.g., rather than directional antennas) at the BS, and each square grid (e.g., bin) in the coverage area may be considered as one sector. In other approaches, ML algorithms of random forest (RF) and multilayer perceptron may be used to predict the optimal BS and WTRU beam pair using GPS coordinates or another location of users, and may be compared with one or more context information schemes, for example a naïve scheme that chooses the closes BS and beam given the location of the WTRU and an inverse fingerprinting technique. Raytracing software (e.g., Wireless InSite) may be used to simulate an urban outdoor environment.

Deep learning-based methods may be used, as described herein. Omni-directional sounding signals from multiple BSs may be used to train a deep learning model to predict the optimal beam. In an example, a prototype validation of the proposed deep learning may be performed. However, this approach may use sub-6 GHz for mmWave channels by assuming that both channels have strong spatiotemporal correlation under certain conditions. A deep learning based solution in switched-beam multi user (MU)-MIMO systems may be used. A deep learning based beam selection strategy that uses location and/or orientation information of users may be implemented. Several support vector machine (SVM) based algorithms may also exist to address optimal beam prediction in mmWave networks. SVM may be combined with an iteration sequential minimal optimization algorithm. SVM may be compared with k-nearest neighbors and multi-layer perceptron using angle of arrival information.

Beam training may be formulated in a multiarmed bandit framework to select the optimal beam pair, and may be compared with exhaustive search method. A machine learning tool of random forest classifier combined with situational awareness may be used to learn the beam information (e.g., power, optimal beam index, etc.) from past observations in vehicular networks.

One or more contextual information-based non-ML techniques may be used. Non-ML approaches that rely on using some additional contextual information to improve the exhaustive search methods may be used. This additional information may be user positions and/or locations, channel gain, user spatial distribution, angle of arrival and departure, past multipath fingerprints, radar signals, sub-6 GHz band information in a control data plane split architecture, and/or antenna configurations. The contextual information-based non-ML techniques may include analytical solutions (e.g., since analytical based solutions usually rely on predefined assumptions). To improve the pure random search algorithm, a greedy search approach, called Discovery Greedy Search may be used. The serving mm-wave BS may know information regarding the position of users from the macro BS C-plane to calculate the optimal beam width and/or pointing direction to reach it. However, if a serving mm-wave BS does not detect a user (e.g., due to positioning inaccuracy), the mm-wave BS may start scanning around through various directions, keeping the same beam-width. If still no user is found, mm-wave BS may restart a circular sweep reducing the beam-width and iteratively scans the larger set of pointing directions. This approach may be compared with an enhanced discovery procedure. In the presence of positioning inaccuracy, the BS may scan the surrounding environment relying on n circular sectors. Within the first scanned sector, the sector pointing to the user position, the BS may start exploring beam directions adjacent to it with a fixed beam-width in order to cover the sector, alternating clockwise and counter-clockwise directions.

Enhanced discovery may provide a tradeoff between opposing methods. For example, performing discovery by scanning first large azimuthal angles and then extending the range by narrowing the beam may provide tradeoffs versus performing discovery by exploring first narrow azimuthal angles until the maximum range is reached and then changing pointing direction. Control and data separation architecture may be used by deriving and optimizing network coverage probability to evaluate the beam mismatch problem. Methods considering the system throughput only may be used (e.g., without considering the frequent beam handoff problem). The sum rate in a switched-beam based MIMO system working at mmWave frequency band may be maximized. Position information from the train control system in high-speed-train communications for beam alignment may be considered. A joint consideration of beamwidth selection and scheduling may be performed to maximize effective network throughput. Using sub-6 GHz out-of-band information to assist mmWave beam steering, a compressed beam-selection may be formulated as a weighted sparse signal recovery problem, and the weighting information from sub-6 GHz channels may be obtained. The training overhead of beam-selection may be reduced by exploiting the spatial clustering of multi-paths in the channel.

Signal processing-based methods may be used. These methods may include kalman filter based methods to track angle of arrival and departure information, and/or an extended kalman filter based method that uses a joint minimum mean squared error (MMSE) beamforming and extended kalman filter tracking strategy to minimize the beamforming angle mismatch. The extended kalman filter estimation approach may be combined with a conditional beam-switching scheme. However, this approach may assume that the devices can switch the beam pattern to any arbitrary direction as the system loses track, which may not be possible in analog beamforming (e.g., where the number of unique beam patterns is limited to the number of antenna elements in the beamforming array). Another signal processing approach that may be used is a particle filter based method, in which the BS tracks the WTRU based on particle filter and adaptively widens or narrows the beam width via the partial activation of the antenna array.

Compressed sensing approaches may be used in which estimation of the spatial frequencies associated with the directions of departure of the dominant rays from the base station, and the associated complex gains by transmitting compressive beacons. However, compressive beaconing may be essentially omnidirectional, and may not enjoy the signal to noise ratio (SNR) and spatial reuse benefits of beamforming obtained during data transmission. Compressed sensing approaches may be compared with an approach utilizing knowledge of the previous angle of departure (AoD)/angle of arrival (AoA) estimates to asymmetrically scan beam space by projecting pseudo-random sequences onto it. Using past multi-path fingerprints, one or more approaches for selecting optimal beam pair may be used. In an example, the WTRU position and/or location may be used to query a multipath fingerprint database from the BS, which gives the prior knowledge of potential pointing directions for beam alignment. One or more types of fingerprinting databases may be used. For example, a first type may have top-M beam pairs ranked according to RSRP level, and a second type may store the average RSRP for each beam pair. The first approach for selecting optimal beam may be heuristic while the other may minimize the misalignment probability by maximizing the received power of the optimal selected beam pair. However, since this method relies on past database, some paths may not exist in the database due to blockages.

A hierarchical search method may be used to reduce latency compared to the exhaustive search method. For example, the BS may first perform an exhaustive sequential search over wider beams then iteratively progress to narrower beams. The hierarchical search method may be combined with AI/ML.

Achieving initial access using directional transmission and reception may come with high latency and/or processing power. For example, an initial robust and reliable link may be found by naively performing extensive beam sweeps, which may take a relatively large amount of time and/or processing power. A method that can reduce both the latency and processing power required for a directional transmission and reception system may be disclosed herein.

An AI-aided initial access scheme may be used to reduce latency and/or processing power utilized in directional transmission and reception based systems. As used herein, the terms “low-latency initial access,” “low-latency cell detection,” “low-latency cell discovery,” and/or “low-latency measurements” may be used interchangeably.

An AI-aided low-latency initial access algorithm may be used. For example, AI/ML may be used to learn an optimal beam/beam pair and/or optimal cell/BS from wider beams (e.g., rather than using an exhaustive search to search over wider beams, as may be performed in a hierarchical search method). Narrow beams may be used to fine-tune the predicted optimal beam pair by exhaustive search. Using AI/ML to learn the optimal beam pair and exhaustive search to fine-tune the predicted optimal beam pair may reduce latency as compared to using an exhaustive search for both, and may take into account a user requirement for selecting whether fine-tuning is needed.

Since the search space may be reduced when wider beams are used as compared to narrower beams, learning optimal beam pair and BS using AI/ML may utilize less resources. Moreover, in emerging ultra-dense network scenarios, BS density may be far greater than macro cells, that may in turn lead to a large number of cell identification/identifier (ID) options or BS classes for the WTRU association. Therefore, training on wider beams may also help to narrow down the number of additional classes due to multiple beam pairs, as fewer wider beams could cover the same coverage area in comparison to narrower beams. Training on wider beams may reduce the probability of over-fitting during the model training stage (e.g., as compared to training on narrow beams). Developing ML models on wider beams rather than narrower beams may lead to more tolerance for error, stemming from characteristics of cellular environments, such as shadowing and multi-paths or inaccurate user positioning.

A system model may be used, and data collection may be performed. Past Minimization of Drive Test (MDT) based reports from mmWave base stations may be used to train an ML algorithm. The MDT reports may contain network coverage-related key performance indicators (e.g., RSRP) measured at the WTRU. These reports may be tagged with the WTRU's geographical location information (e.g., WTRU position, WTRU location, etc.) and then sent to their serving base stations. Synthetic data that is generated through a 3GPP-compliant simulator may be used to explore the techniques disclosed herein. For example, a 3GPP-defined indoor scenario of 5G indoor office may be used. Scenario parameters for channel modeling implemented in the simulator may include parameters related to delay spread, angle of arrival and departure spreads, shadow fading, k-factor, cross-correlations, number of clusters, and/or rays per cluster, among others. These parameters may be defined for both LoS and NLoS paths.

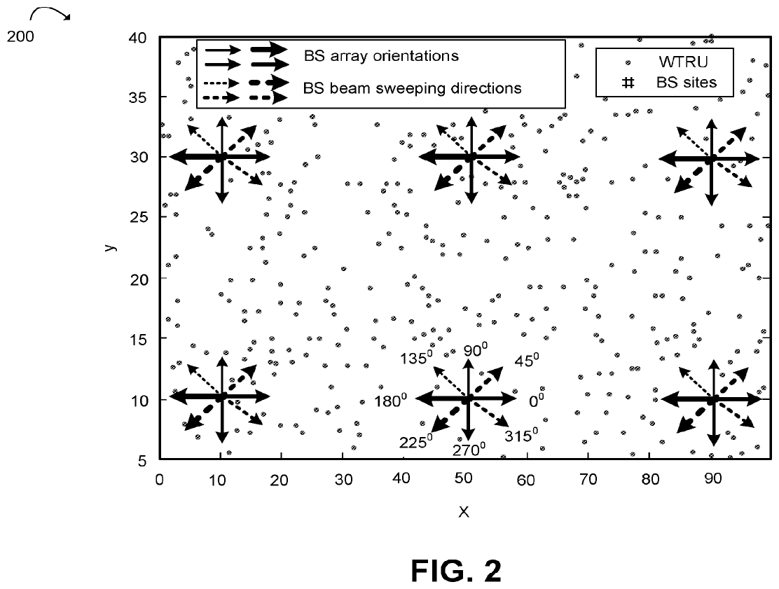

FIG. 2 illustrates an image 200 of an example network topology showing base station (BS) locations, array orientations, sweeping directions, and a sample WTRU distribution for channel modeling implemented by the simulator. In this example, a total of 15,000 WTRUs may be dropped in the simulation area. To avoid over-fitting, 5-fold cross validation may be used. There may be 6 BSs in the simulation area, each with 4 arrays rotated about the z-axis by at 0, 90, 180, and/or 270 degrees, resulting in 24 total number of BSs. Each array may consist of 2×1 antenna elements, which may result in a wide beam width of approximately 60 degrees. The antenna element pattern may be 3GPP defined, with 3D Gaussian element generation method, azimuth and elevation 3 dB beamwidths of 65 degrees, maximum gain of 8 dB, front to back ratio and side lobe ratio of 25 dB and tilt angle of 12 degrees. The WTRUs may have omni-directional antennas. The RSRP steering angle may take the values of 0 and 45 in the azimuth direction, which means for every BS, beam sweeping will be performed in these two directions. There may be a total of 2 beam pairs for each of the 24 BSs, as shown in FIG. 2.

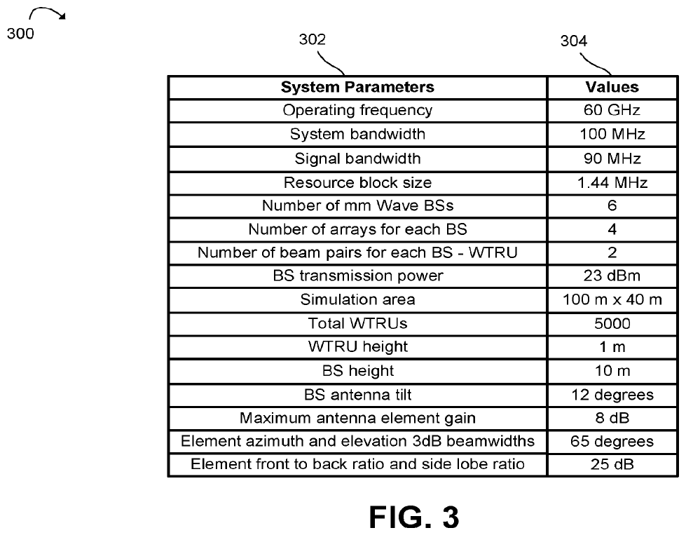

The rest of the simulation parameters may be as shown in FIG. 3. FIG. 3 includes a table 300 that includes system parameters 302 and corresponding values 304 implemented in the simulation.

A two-phase cell selection and/or beam association process may be implemented using an AI-assisted framework, as described herein. For example, the framework may include AI-aided cell discovery in emerging networks (AIDEN) that implements AI/ML. In the AIDEN framework, mmWave user historic minimization of drive test (MDT) traces that contain coverage quality indicators (e.g., RSRP and/or location) may be gathered. The AIDEN framework may include using AI techniques on wider beams and transitioning to narrower beams to further fine tune the predicted optimal beam pair in the first phase (e.g., considering a user requirement). AIDEN may be more robust to over-fitting during the model training stage and/or may give more tolerance for error resulting from propagation characteristics of the environment (e.g., compared to other AI-based search methods, which may use AI for narrower beams and may use a larger search space). Additionally or alternatively, AIDEN may avoid phase 1 latency while also maintaining a comparable accuracy to hierarchical search based methods.

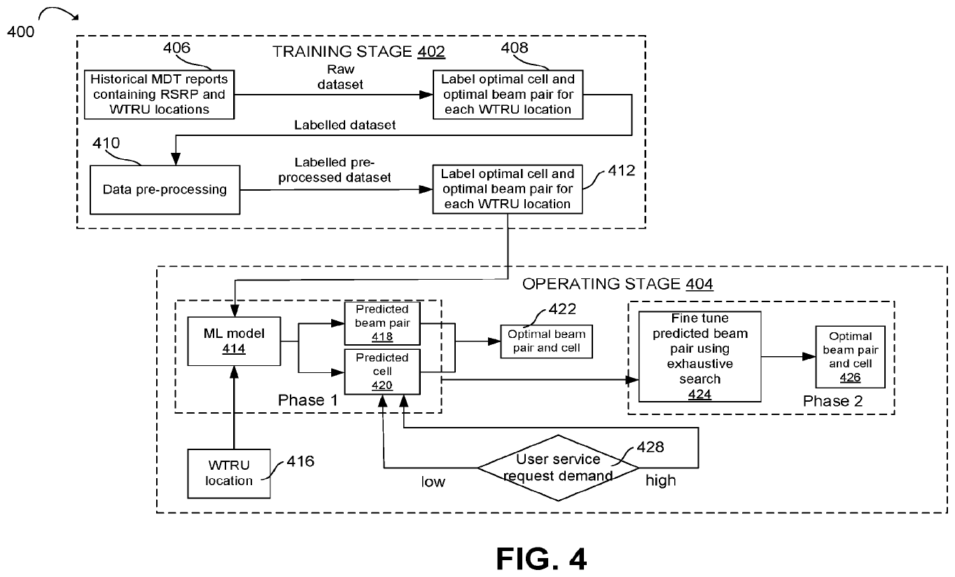

FIG. 4 illustrates an example process 400 that may be implemented for performing cell selection and/or beam association using AI/ML. For example, the process 400 may be implemented utilizing an AIDEN framework. One or more portions of the process 400 may be implemented at a network entity, such as a BS or a network server in communication with a BS, for implementing AI/ML for cell selection and/or beam association. Additionally, though one or more portions of the process 400 may be described as being implemented by a BS or another network entity, one or more portions of the process 400 may be implemented by other devices on the network, such as a WTRU, another BS, or another network server.

As shown in FIG. 4, the process 400 may include a training stage 402 and/or an operating stage 404 (e.g., also referred to as a production stage). During the training stage 402, a training dataset may be constructed and an AI/ML model may be implemented in the operating stage 404. As shown in FIG. 4, historic reports from mmWave cells consisting of WTRU GPS location and RSRPs of nearby cells may be logged at 406. The historic reports may be used as the raw dataset, which may be preprocessed as described herein. The optimal cell/BS and optimal beam/beam pair may be labeled at 408 for each WTRU location in the training data. In the simulations, cell association and beam pair association may be done on the basis of highest RSRP. The labelled dataset may be preprocessed at 410 to generate data in a format for being input into the ML. Using the labelled pre-processed dataset, associated cell ID and beam pair maps may be created for each WTRU location at 412. Each user location may be labelled with a 2-tuple, (associated cell ID, associated beam pair). Further pre-processing of training data may be done (e.g., depending on the capability of ML algorithms). The training stage 402 may include training done by inputting one or more WTRU location(s) and/or one or more RSRP value(s) (e.g., at 406). The training stage may include determining a cell/gNB and/or beam association via the AL/ML model and/or comparing the gNB or beam association to an optimal cell/gNB and/or an optimal beam association (e.g., obtained via exhaustive search). The training stage may include a cost function. The cost function may include minimizing the (e.g., total) cost when performing the comparison. For example, minimizing the cost may include minimizing the difference between a WTRU-measured RSRP value of a signal transmitted from the AI/ML selected strongest (e.g., best) beam and the optimally determined (e.g., via exhaustive search) AI/ML selected strongest (e.g., best) beam.

For AI/ML algorithms that do not directly support multi-class multi-output classification, a multi-class single-label classification may be used (e.g., with a label powerset method), where each 2-tuple consisting of (associated cell ID, associated beam pair) is assigned a unique integer. In this way, one multi-class classifier is trained on one or more (e.g., all) unique label combinations found in the training data.

Outliers in the training data (e.g., WTRUs far away from a particular BS being associated with that BS) may be filtered out based on a distance threshold between the WTRU and BS, that defines the range of BS. Outliers may be defined as WTRU-BS distance values more than 1.5 interquartile ranges above the upper quartile (75 percent) or below the lower quartile (25 percent).

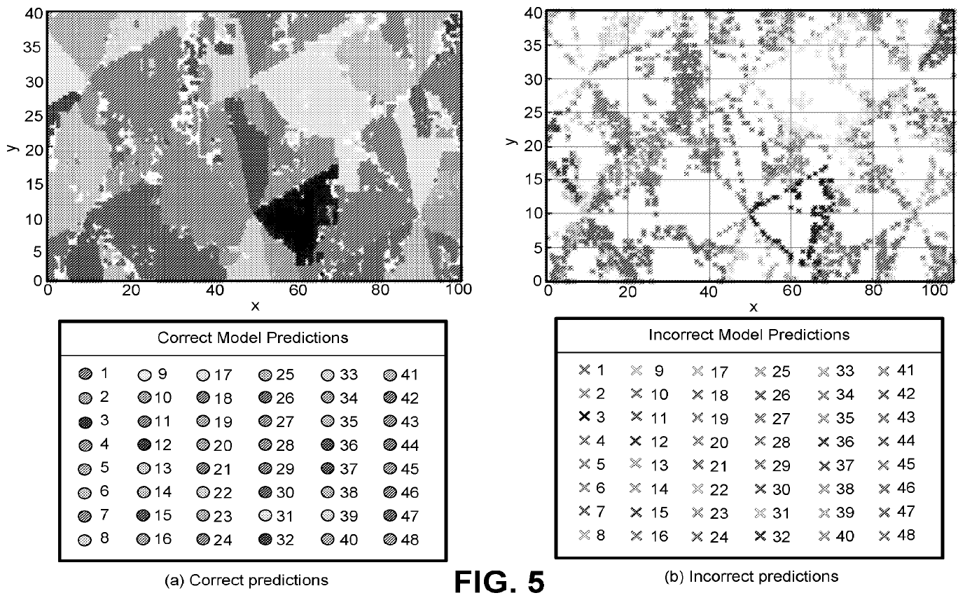

The operating stage 404 may include a first phase and/or a second phase. As shown in FIG. 4, given a WTRU location 416 (e.g., x and y geographical coordinates, a Global Navigation Satellite System (GNSS) or GPS location, and/or another geolocation of a WTRU) as input, one or more AI/ML algorithms 414 may be used to predict an optimal beam pair at 418 and/or predict an optimal cell/BS at 420. The optimal BS and/or optimal beam pair (BP) may be output at 422. One or more of the AI/ML models may be trained (e.g., during the training stage 402 and prior to the operating stage 404 procedures described herein) to take as an input location coordinates (e.g., possibly along with other inputs such as service requirements, WTRU identity, interference, etc.). The one or more AI/ML models may be trained to output a set of one or more of: cell(s), gNB Tx beam(s), WTRU Rx beams(s), beam-pair(s), gNB Rx beam(s), and/or WTRU Tx beam(s). The training may be done by one or more (e.g., multiple) WTRU's reporting location (e.g., and/or any of the inputs as described herein). The training may include performing (e.g., exhaustive) cell/beam search to determine strongest cells/beams. The training data using wide beams may be used to train several ML algorithms, including support vector machines (SVM), k-nearest neighbor (KNN), random forest (RF), and/or deep neural networks (DNN). KNN may be chosen because it is easy to implement, fast, and requires hyperparameter tuning of just three variables. KNN classifies the new data points based on the similarity measure of the historical data points. KNN may not scale well with large number of input variables and may require homogeneous features. Two input variables (e.g., WTRU x and y coordinates) may be used, and they may be on a homogeneous scale (e.g., meters). KNN's sensitivity to outliers and noise may be addressed through pre-processing of data (e.g., as described herein). SVM may be chosen because the classification decision is dictated by figuring out the decision boundaries/hyperplanes. For example, the margins or boundaries separating the classes may be visualized (e.g., as shown in FIG. 5). Data non-linearity may be handled (e.g., via a kernel trick).

SVM may be memory extensive as it may require storing one or more (e.g., all) support vectors which grow with the training dataset size. RF may be a collection of decision trees, and the majority vote of the forest may be selected as the predicted output. Compared to decision trees, RF may be less vulnerable to over-fitting, resulting in a more robust solution. Compared to KNN, random forest may support automatic feature interaction and may be (e.g., usually) faster. In comparison to SVM (e.g., that uses a kernel to solve non-linear problems) each decision tree in random forests may derive hyper-rectangles in input space to solve such problems. Moreover, decision trees may tackle collinearity better than SVM.

DNNs may be capable of directly supporting multi-class multioutput classification tasks, however, they often have non-linear activation functions and computing their gradients may be computationally expensive during backpropagation of the error. DNN may be used (e.g., directly) to predict two output variables (e.g., optimal BS and optimal beam pair), but different strategies may be employed to utilize KNN, SVM and/or RF. For KNN, the 24 classes for BS and 2 classes of beam pair for each BS may be converted to 48 unique classes. SVM, being an inherently binary classification algorithm, may need modifications for both multi-output and multi-class classification tasks. Multi-class classification may be subdivided into multiple binary classifications via one-to-one and one-to-all methods, which may be the additional hyperparameter options used to tune the SVM model. For decision trees, one classifier per output may be fitted.

The operating stage 404 shown in FIG. 4 may include a second phase. In the second phase, the predicted beam/beam pair may be fine-tuned at 424 to generate an optimal beam/beam pair and/or cell/BS 426. The second phase may be performed based on requested user service demand at 428. For example, if a user requested demand is determined to be higher at 428, a narrower beam may be determined. If user requested demand is determined low, a wide beam may be used. Depending on the requested user demand at 428, one or more narrow beams may be used. Exhaustive beam sweeping may be performed, for example roughly confined within the beamwidth of the predicted beam from the first phase. This may further refine the predicted beam from the first phase, as shown in FIG. 4. The second phase may refine the cell/beam determined by the AI/ML. The AI/ML model may return a beam with a wide beamwidth. The second phase (e.g., refinement step) may include determining a beam with a narrow beamwidth. The second phase may use one or more AI/ML model(s).

As used herein, the term “beam” or “beam pair” may refer to any of an uplink (UL)-transmit (Tx) beam, a downlink (DL)-Tx beam, an UL-reception (Rx) beam, and/or a DL-Rx beam. The term “beam” or “beam pair” may refer to one or more of the following: a DL-Tx beam (e.g., the beam used by the gNB in a DL transmission), DL-Rx beam (e.g., the beam used by the WTRU in a DL reception), UL-Tx beam (e.g., the beam used by a WTRU in a UL transmission), UL-Rx beam (e.g., the beam used by the gNB in a UL reception), DL Tx-Rx beam-pair (e.g., the beams used by the WTRU and gNB for DL transmissions), UL Tx-Rx beam-pair (e.g., the beams used by the WTRU and gNB for UL transmissions). It may be assumed that a UL Tx-Rx beam pair may use the same beams as for a DL Tx-Rx beam pair. In such cases, the UL Tx beam at the WTRU may be the same as the DL Rx beam at the WTRU (e.g., they both use the same spatial filtering) and the UL Rx beam at the gNB may be the same as the DL Tx beam at the gNB (e.g., they both use the same spatial filtering).

A beam pair determined in one direction (e.g., DL) may be used by the WTRU to transmit in the UL. For example, the WTRU may determine an UL Tx beam to be the same as a determined DL Rx beam, and the WTRU may determine UL transmission resources as a function of a DL Tx beam used by the gNB.

A WTRU location report may include coordinates that indicate a given position and/or location of a WTRU. The WTRU location report may be configured with a given granularity. For example, a WTRU may be configured with one or more areas and the WTRU may determine its location as being within a given area. The WTRU may report an area or an area index to the gNB. Reporting may include sending an indication of information indicating the WTRU location, as described herein. The indication may be explicit, to explicitly indicate the WTRU location. The indication may be implicit, to implicitly indicate the WTRU location. The indication may be both explicit and implicit.

The WTRU may determine its location relative to one or more cell or DL-Tx beam(s) and/or beam-pair(s). The WTRU may report its relative location, for example along with the DL-TX beam or beam-pair or Reference Signal (RS) index to which the relative location is applicable.

A WTRU location report may include one or more positions and/or locations of the WTRU, including one or more of the following: coordinates, area or area index, and/or measurement(s) performed on one or more signals (e.g., signal(s) configured to enable WTRU location determination).

Signaling may be performed to support cell discovery. Signaling to support cell discovery may be used for determining an Rx beam on a pair and/or use an UL beam corresponding to the beam pair. A WTRU may report its location to the network, for example to enable AI-aided cell discovery. In an example, the WTRU may detect a first cell and DL-Tx beam combination, for example from a subset of all possible cell and DL-Tx beam combinations. The WTRU may detect the first cell and DL-Tx beam combination by receiving a DL transmission from the first cell and DL-Tx beam combination. The WTRU may determine UL resources on which to transmit its location, from the DL transmission of the first cell and DL-Tx beam combination. For example, the WTRU may detect a broadcasted transmission providing resources on which to transmit its location. For example, the transmission may include system information (SI) that indicates one or more resources on which to transmit its location

A WTRU may report its location along with a temporary identification tag. For example, the WTRU may report its location with a preamble. A WTRU may report its location by transmitting a signal in a resource. A parameter of such a signal transmission may indicate the WTRU's location and/or a WTRU ID. The WTRU may report other contextual information. For example, other contextual information may be implemented here (e.g., antenna configuration and the like). The location of the WTRU may be indicated by one or more of the following: the resource (e.g., time or frequency) on which the WTRU transmits the signal; the signal structure; an associated preamble; and/or the contents of the signal.

The location of the WTRU may be indicated by the resource on which the WTRU transmits the signal. For example, the WTRU may be configured with (e.g., or indicated via broadcast transmission) a mapping between signal resource and a geographical region. The time of the resource may be defined in terms of symbol(s) or slot(s). The frequency of the resource may be defined in terms of Physical Resource Blocks (PRBs) or subcarrier(s) or Bandwidth Parts (BWPs).

The location of the WTRU may be indicated by the signal structure. For example, the WTRU may select a transmit sequence as a function of its location.

The location of the WTRU may be indicated by an associated preamble. For example, the WTRU may be configured with one or more sets of preambles or PRACH occasions, where a (e.g., each) set may be associated with a different WTRU location (e.g., or different WTRU location area). The WTRU may select a preamble or PRACH occasion associated with the location or area where the WTRU is located.

The location of the WTRU may be indicated by the contents of the signal. For example, the WTRU may encode its location into the signal. The encoding may be done via scrambling of a set of bits (e.g., CRC bits).

The WTRU may report its location to a serving cell. The WTRU may be triggered to report its location when one or more of the following occurs: the WTRU location changes by more than a threshold amount; the WTRU is triggered to report L3 measurements; the WTRU is triggered for conditional handover (HO); the RSRP is less than a threshold value; the serving cell RSRP is less than a neighbor cell RSRP value plus offset; the WTRU's transmission requirements change; the WTRU's best Rx-beam changes; the WTRU's best UL panel changes; the WTRU detects a new cell or DL-Tx beam or combination thereof; the WTRU determines N or more NACKs for DL transmissions (e.g., in a pre-determined time period); a configurable, periodic, or pre-determined triggering event occurs; the WTRU's speed changes by more than a threshold amount; and/or the WTRU determines that it has failed channel access more than N times (e.g., in a pre-determined time period).

The WTRU may be triggered to report its location when the WTRU detects a new cell or DL-Tx beam or combination thereof. For example, if the WTRU detects a new cell and/or DL-Tx beam with RSRP greater than a threshold, the WTRU may report its location.

The WTRU may be configured to perform neighbor cell discovery/measurement based on low-latency cell detection using assistance information. The WTRU may be configured with one or more neighbor cells for which low latency cell detection may be enabled. For example, the WTRU may be configured to trigger a location report to the network when measurements are triggered for at least one neighbor for which low latency cell detection is enabled. The WTRU may receive assistance information from the gNB. For example, the WTRU may receive the assistance information from the gNB (e.g., in response to transmission of its location and/or other contextual information), as described herein. The WTRU may determine assistance information (e.g., as a function of its location and/or other contextual information as described herein). The function to determine assistance information may include AI/ML. The function to determine assistance information may include the WTRU being configured (e.g., via broadcasted SI and/or via Radio Resource Control (RRC)) with an association between one or more location(s) and one or more set(s) of assistance information. The assistance information may include a defined subset of measurement resources for a cell and/or at least one beam in a beam pair based on the WTRU's location. For example, the assistance information may include one or more of the following: one or more measurement objects; a set of resources to monitor for a discovery signal or a synchronization signal block (SSB); and/or a mini measurement gap configuration (e.g., the gap may be smaller in duration compared to a regular/legacy measurement gap).

The assistance information that the WTRU receives from the gNB may include one or more measurement objects. For example, the WTRU may be configured with prioritized list of one or more neighbor cells and/or frequencies. The WTRU may prioritize these neighbors for performing measurements and/or reporting.

The assistance information that the WTRU receives from the gNB may include a set of resources to monitor for a discovery signal or SSB. For example, the set of resources may be configured as a SMTC window specific to low latency cell detection. For example, the WTRU may be configured with information such as SSB index (e.g., or any implicit/explicit beam identification) expected to be received within the SMTC window.

The assistance information that the WTRU receives from the gNB may include a mini measurement gap configuration. For example, the WTRU may be configured to monitor for discovery signal and/or SSB from the neighbor cells within this mini measurement gap configuration. The WTRU may apply the mini-measurement gap configuration as an alternative to a regular measurement gap configuration. The WTRU may apply the mini-measurement gap configuration for measurements in addition to a regular measurement gap configuration.

The assistance information may be signaled via a radio resource control (RRC) message and/or MAC control element (CE). The Medium Access Control (MAC) control element may activate or deactivate a preconfigured measurement configuration. The WTRU may be configured to use the assistance information to perform neighbor cell discovery and/or measurements (e.g., measurement resources). The WTRU may be configured to report the neighbor cell measurements to the gNB. The WTRU may be configured to report the cell discovery (e.g., including one or more associated measurements) to the gNB. The WTRU may be configured to report the neighbor cell measurements via a preconfigured UL resource. Reporting may include sending an indication of information indicating the neighbor cell measurements. The indication may be explicit, to explicitly indicate the neighbor cell measurements. The indication may be implicit, to implicitly indicate the neighbor cell measurements. The indication may be both implicit and explicit. A preconfigured UL resource may be determined as an offset from the timing of assistance information or a configured as a part of assistance information or determined implicitly based on the content of the assistance information.

WTRU-centric cell discovery may occur. A WTRU may be provided with an association of WTRU locations with resources on which to transmit a signal or with an associated cell or DL-Tx beam. The WTRU may transmit a signal in the resource as determined by its location and/or service requirements. The WTRU may monitor for a response. The resources on which the WTRU monitors for a response may also be determined by the WTRU location and/or service requirements.

The granularity of the received association between WTRU locations and resources on which to transmit a signal or with an associated cell or DL-Tx beam may be such that the WTRU may need to interpolate to determine the appropriate resources of cell or DL-Tx beam. The WTRU may use AI/ML to perform the interpolation. In examples, there may be an association with a location and a resource on which to transmit a signal. The association may have a certain granularity. If a WTRU is located between two locations (e.g., two locations for which there is an associated transmission resource), the WTRU may input its location to an AI/ML model (e.g., possibly along with other inputs) and/or the output may provide the transmission resource.

A WTRU may determine a preferred cell (e.g., of a BS) or beam or beam-pair. For example, the WTRU may determine a preferred cell (e.g., of a BS) or beam or beam pair based on its location. The WTRU may report the preferred cell (e.g., of a BS) or beam or beam-pair to a gNB. Reporting may include sending an indication of information indicating the preferred cell (e.g., of a BS) or beam or beam-pair. The indication may be explicit, to explicitly indicate the preferred cell (e.g., of a BS) or beam or beam-pair. The indication may be implicit, to implicitly indicate the preferred cell (e.g., of a BS) or beam or beam-pair. The indication may be both explicit and implicit. The WTRU may be configured with resources on which to report the preferred cell (e.g., of a BS) or beam or beam-pair to at least one gNB. The WTRU may report the preferred cell (e.g., of a BS) or beam or beam-pair on the same resources that are received for reporting location information. The WTRU may report the preferred cell (e.g., of a BS) or beam or beam-pair on one or more different resource(s). The WTRU may report the preferred cell (e.g., of a BS) or beam or beam-pair on resources configured specifically for reporting location information. The WTRU may be configured with a plurality of resources on which to transmit a signal. The WTRU may select a resource as a function of a preferred cell (e.g., of a BS) or beam or beam-pair. For example, the WTRU may be configured with one or more set(s) of reporting resources. The one or more set(s) of reporting resources may be associated with one or more preferred cell (e.g., of a BS) and/or beam and/or beam-pair. The WTRU may transmit a UL signal on the resource. The UL signal may include information or measurements for one or more cell(s) or beam(s) or beam-pair(s) (e.g., including at least the preferred cell of a BS or beam or beam-pair).

Upon transmitting an indication of a preferred cell of a BS or beam or beam-pair, the WTRU may monitor for an acknowledgement from a gNB. The acknowledgement may be received via one or more of: Random Access Response (RAR), scheduling grant, RRC (re) configuration, DL RS, Downlink Control Information (DCI).

A WTRU may indicate service requirements to the network. This may indicate to the network whether it may be served by a narrow beam or a widebeam. A WTRU may be indicated a cell and DL-Tx widebeam (e.g., as determined by an AI-ML method) and may begin operation immediately. In an example, a WTRU may be indicated a cell and a DL-Tx widebeam and may be triggered to perform refined beam selection, for example to narrow the serving DL-Tx beam.

A WTRU may indicate one or more of its service requirements (e.g., amount of data, reliability requirements, latency requirements, data type) to the gNB. The service requirements may include one or more thresholds (e.g., latency thresholds, RSRP thresholds, etc.). The gNB may use the one or more service requirement(s) of the WTRU to determine the appropriate beam to serve the WTRU with. The service requirements may indicate the WTRU's serving cell DL-Tx beam requirements (e.g., narrow beam or wide beam). A WTRU may indicate its service requirements via a transmission of a signal prior to the completion of cell discovery. For example, the WTRU may encode its service requirements using a manner similar to the location reporting methods described herein. Alternatively, the WTRU may indicate its service requirements via transmission of a signal after completion of coarse cell discovery. For example, upon completion of coarse cell discovery, a WTRU may be provided resources on which the WTRU may transmit its service requirements. For example, such a transmission may use a scheduling request (SR)-like operation, whereby the WTRU is configured with one or more, possibly periodic, resource(s) on which the WTRU may indicate a change to (e.g., update of) one or more service requirement(s). The transmission may use a SR-like operation, whereby the WTRU is configured with one or more (e.g., possibly periodic), resource(s) on which the WTRU may indicate a new set of service requirements.

Upon completion of coarse cell discovery, a WTRU may receive transmissions to enable finer beam selection. The WTRU may perform fine beam selection if it determines that its service requirements justify it. The WTRU may skip the fine beam selection and/or may indicate to the network that it does not need fine beam selection. Beam refinement may be done via an exhaustive search. In order to implement an exhaustive search, the WTRU may be configured with a set of resources (e.g., a set of reference signals) to measure one or more beams within a set of beams. For example, the set of resources may include a set of reference signals for measuring each of the possible finer beams. The WTRU may report the appropriate values within a wider or narrower beam. Appropriate values may include one or more measurements, as described herein. Additionally or alternatively, the WTRU may use other means (e.g., AI/ML based) to receive transmissions to enable finer beam selection.

A WTRU may receive an indication from the network that it has been associated with a cell and/or DL-Tx beam. For example, a WTRU may monitor for a DL transmission from the network (e.g., after providing its location to the network). The WTRU may monitor for a set of discovery signals or SSBs. The set of discovery signals or SSBs to be monitored by the WTRU may be determined as a function of the location the WTRU has provided the network and/or as a function of an ID the WTRU has provided the network. The WTRU may ignore any other discovery signal or SSBs that are not associated with its reported location or ID.

A WTRU reporting a first WTRU location may be configured to monitor a first set of resources on which it may expect at least one discovery signal or SSB. Upon reception of at least one discovery signal or SSB, the WTRU may proceed with random access. The WTRU may perform random access using the determined cell, beam, and/or beam pair. The WTRU may attempt to decode a discovery signal or SSB using its reported ID or location (or location ID or tag). For example, the SSBs may be scrambled with WTRU IDs or location tags. The WTRU may select an SSB as one for which its location or ID appropriately unscrambled the SSB.

A WTRU may decode an Information Block that may include a set of resources associated to WTRU locations. The WTRU may perform random access on the resources indicated in the Information Block associated to its location.

A WTRU may be configured with measurement resources (e.g., associated with its location). For example, after transmitting its location, the WTRU may be configured with a set of measurement resources. The WTRU may perform measurements and/or report measurements for at least one cell or beam or beam-pair. The measurements may include one or more of the following: RSRP, Received Signal Strength Indicator (RSSI), Reference Signal Received Quality (RSRQ), Signal to interference and noise ratio (SINR), Rank Indicator (RI), Channel Quality Indicator (CQI), Precoding Matrix Indicator (PMI), Layer Indicator (LI), CRI, Doppler shift, Doppler spread, angle of arrival (AoA), angle of departure (AoD), delay spread, and/or average delay. A WTRU may report measurements using resources associated with at least one measurement resource. A WTRU may report measurements using a resource associated with the measurement resource which provides the best measurements (e.g., highest RSRP, or SINR, or RSRQ). A WTRU may perform a transmission (e.g., to report measurements) using a cell or beam or beam-pair as selected by an outcome of the measurements performed on the configured measurement resources. Reporting may include sending an indication of information indicating one or more measurement resources. The indication may be explicit, to explicitly indicate the one or more measurement resources. The indication may be implicit, to implicitly indicate the one or more measurement resources. The indication may be both explicit and implicit.

A WTRU may determine a set of cells, beams, and/or measurement resources as a function of its location and/or broadcast information (e.g., a system information block (SIB)). The WTRU may be configured (e.g. via SI, or RRC, or MAC CE, or DCI) with an association between location and SIB information and a set of cells, beams, and/or measurement resources. The WTRU may perform measurements on the set of cells and/or beams and/or measurement resources, and may report measurements to the gNB along with an identifier for the set of cells and/or beams and/or measurement resources.

A WTRU may receive an indication of a cell or DL-Tx beam to which it may be associated. Upon reception of an indication of best cell or DL-Tx beam, a WTRU may perform random access (RA) to that cell. The indication of cell or DL-Tx beam may include a reference signal (RS) configuration associated with the cell/beam. A WTRU may perform a measurement on the RS. The WTRU may receive resources on which to perform RA or a first transmission to the indicated cell/beam. In such an RA or first transmission, the WTRU may report measurements performed on the associated RS.

If the measurements obtained by the WTRU are below a threshold and/or another measured value (e.g., measurement), the WTRU may decline the cell/beam combination and/or may determine to perform legacy cell discovery. In an example, a WTRU may simultaneously perform enhanced cell discovery (e.g., by indicating its location to the network) and/or legacy cell discovery (e.g., by detection of discovery signals or SSBs). The WTRU may receive an indication of a cell/DL-Tx beam combination from the network. The WTRU may perform measurements on the indicated cell/DL-Tx beam combination. The WTRU may report the measurements of the indicated cell/DL-Tx beam combination, possibly in combination to measurements obtained on WTRU-detected discovery signals or SSBs. This may enable the BS or other network entity to refine its cell discovery algorithm to provide better cell association results. In an example, in which the cell discovery algorithm includes an AI/ML algorithm, the cell discovery algorithm may be refined to provide better cell association results. In cases where the measurements (e.g., RSRP, RSSI, RSRQ, SINR, RI, CQI, PMI, LI, CRI, Doppler shift, Doppler spread, angle of arrival (AoA), angle of departure (AoD), delay spread, average delay, etc.) of the indicated cell/DL-Tx beam combination is less than that WTRU-discovered cell/DL-Tx beam plus offset, the WTRU may ignore the indicated cell/DL-Tx beam and may proceed with accessing the WTRU-discovered cell/DL-Tx beam. The WTRU may indicate to the WTRU-discovered cell that it has ignored a network-determined cell/DL-Tx beam. The WTRU may provide measurements for the network-determined cell/DL-Tx beam to the WTRU-discovered cell.

Parameters (e.g., weights, biases, and/or other hyperparameters) of the AI/ML may be refined by updating the parameters, as described herein. Hyperparameter tuning of AI/ML models may be performed through Bayesian optimization. For example, the tuning of the AI/ML models that are used in the first phase of the procedure to determine cell/beam from location, service requirements, and/or other contextual information may include hyperparameters that may be refined by tuning through Bayesian optimization. Optimal hyperparameters obtained may be as follows: for KNN, number of neighbors=1, distance metric=Euclidean, distance weight=squared inverse; for SVM, kernel function=Gaussian, kernel scale=1.5255, box constraint level=3.4541, multi-class method=one-vs-all; for RF, number of trees=65, maximum depth of tree=50, maximum features for best split=2, bootstrap=True, out of bag score=True.

An AI-aided cell discovery framework for ultra-dense emerging networks with high BS density, AIDEN, may be implemented as disclosed herein. As compared to the hierarchical search algorithm (e.g., which may utilize exhaustive search to search for optimal cell and beam pair using wide and narrow beams), AIDEN may use AI in the search phase having wide beams. AIDEN may be implemented with or without the exhaustive search in a first phase of cell reselection and/or beam association for reducing latency. Then (e.g., depending on the user requirement), narrow beams may be used to further fine tune the predicted beam from AI. AIDEN may be trained on wider beams (e.g., only), which may make AIDEN robust to over-fitting and outliers, and a number of BS classes in an ultra-dense network scenario may be reduced.

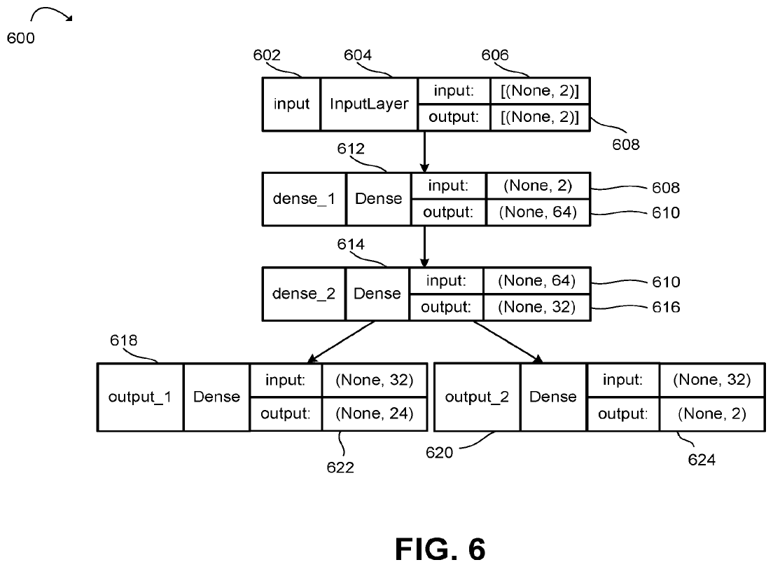

FIG. 6 shows an example of a DNN architecture 600 and hyperparameters that may be configured for the DNN architecture. The DNN architecture 600 may be implemented by AI/ML operating on one or more devices, as described herein. For example, one or more portions of the DNN architecture 600 may be implemented on a network entity, such as a BS or a network server in communication with a BS, for implementing AI/ML for cell selection and/or beam association. Additionally, though one or more portions of the DNN architecture 600 may be described as being implemented by a BS or another network entity, one or more portions of the DNN architecture 600 may be implemented by other devices on the network, such as a WTRU, another BS, or another network server.

As shown in FIG. 6, the DNN architecture 600 may receive an input 602 at an input layer 604. The input 602 may include location information and/or other contextual information, as described herein. The input layer 604 may receive an input 606. The input 606 may have a tensor configuration of [(None, 2)]. The input layer 604 may generate an output 608. The output 608 may be passed to a dense layer 612. The dense layer 612 may receive the output 608 from the input layer 604 as input. The dense layer 612 may generate an output 610. The output 610 from the dense layer 612 may be passed to a dense layer 614. The dense layer 614 may receive the output 610 from the dense layer 612 as input. The dense layer 614 may generate an output 616. The dense layer may feed the output 616 to one or more output layers.

As shown in FIG. 6, the a DNN architecture 600 may include a output layer 618 and/or a output layer 620. The output layer 618 may be a dense layer that receives the output 616 of the dense layer 614 as input. The output layer 618 may provide an output 622. The output 622 may include an identifier of a base station and/or cell (or set of cells) that may be provided to a WTRU in response to a location. The output layer 620 may be a dense layer that receives the output 616 of the dense layer 614 as input. The output layer 620 may provide an output 624. The output 624 may include a set of resources that may be provided to a WTRU in response to a location.

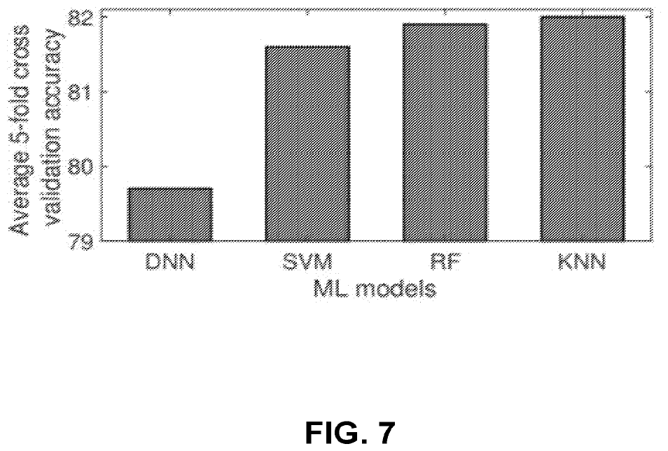

A 5-fold cross validation strategy may be carried out to minimize overfitting during the model training stage. The 5-fold cross validation average accuracies of the aforementioned models may be as shown in FIG. 7. For RF and DNN, which predict two explicit outputs (e.g., unlike SVM and KNN in which multi-output labels are converted to single output), the accuracies reported in FIG. 7 may be an exact match (e.g., subset accuracy), which may indicate the percentage of samples that have each of their labels classified correctly. KNN may perform best in terms of accuracy as number of features in the data are small compared to training data. SVM may generally outperform KNN, for example in cases where there are large features and lesser training data. Performance of DNN may be worse than SVM. There may be well-defined boundaries, although non-linear (e.g., as can be visualized from results as shown in FIG. 5). These boundaries drawn by the neural network may be somewhat arbitrary as they may depend on a number of factors that are random, such as the initialization of the weights.

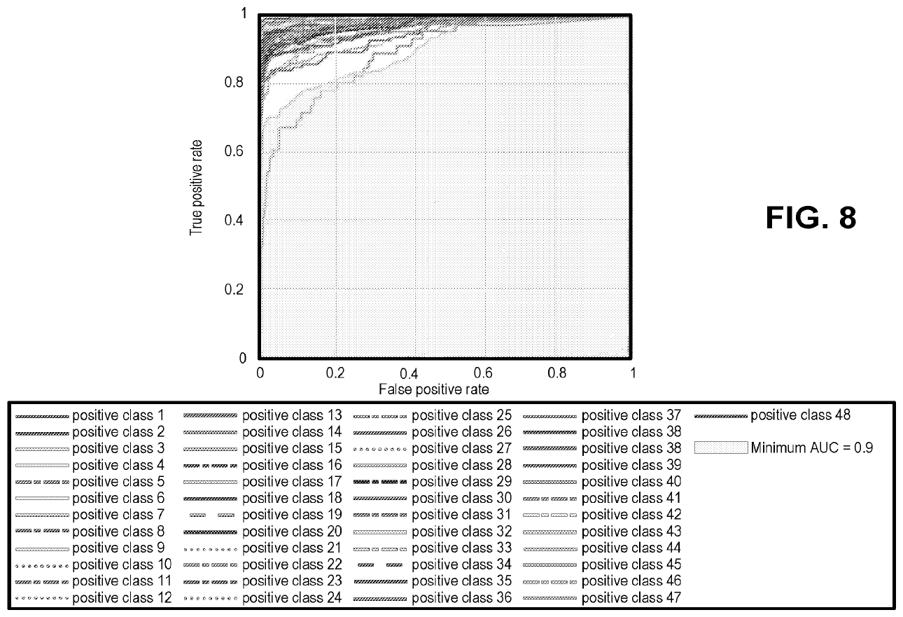

SVMs may draw the optimal boundary in a more structured way by using support vector points. A dataset with two input features may not need a DNN type architecture to extract hidden features from a large number of input features. However, the maximum accuracy may be limited by the fact that there are a large number of classes (e.g., 48). The receiver operating characteristic (ROC) of the best performing AI/ML algorithm, KNN is shown in FIG. 8. Multi-class predictions may be reduced to multiple sets of binary predictions, by considering one positive class at a time while all others being considered negative. The minimum area under the ROC curve (AUC) may be 0.90, while the maximum may be 1.00. The macro averaged AUC is 0.977, which is close to the ideal 1.00, indicating that ML techniques may be used to reduce the latency during phase 1 of AI/ML algorithms, such as AIDEN (e.g., even with a relatively large number of classes).

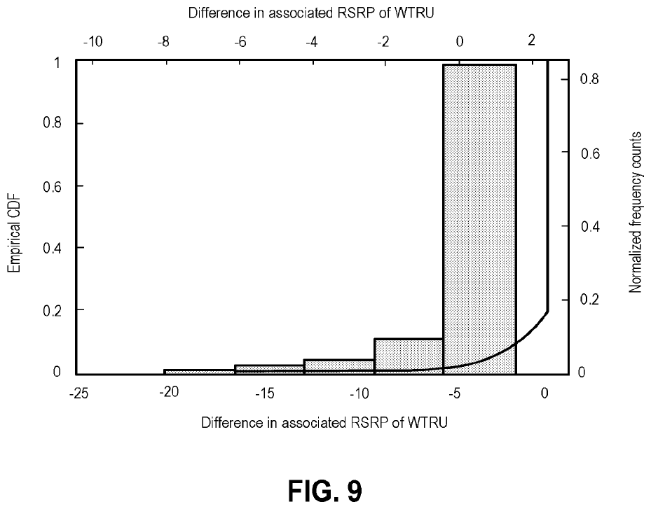

Referring again to FIG. 5, the graphs shown in FIG. 5 illustrate examples of the WTRU locations having correct predicted classes and those that are incorrectly predicted. As shown in FIG. 5, the points that are predicted incorrectly may lie mainly on the cell edges. One way to measure or gauge the impact of incorrect predictions may be to investigate by what amount a key performance indicator (e.g., RSRP, SINR, throughput) corresponding to the target class label differs from the predicted class label. FIG. 9 shows the distribution of difference between RSRP of WTRU corresponding to the predicted BS and beam pair and the RSRP corresponding to the target/actual BS and beam pair on a sample unseen test data of 1000 WTRUs. As shown in FIG. 9, 80% of the WTRUs may have zero RSRP difference (e.g., correct predictions of optimal BS and beam pair) and 2.7% of the WTRUs may have difference of less than only 5 dB in RSRP due to misclassification, and there may be no WTRUs having a difference of greater than 10 dB.

One or more of the embodiments disclosed herein may reduce latency compared to an exhaustive search. Predictions at the cell edge may be improved. Phase 1 of the AI/ML (e.g., AIDEN) framework may be skipped (e.g., for time critical use cases). The AI/ML (e.g., AIDEN) framework may be applied to NLoS paths and in the presence of blockages in the environment (e.g., since mmWave propagation is vulnerable to blockages). The framework may be applied to WTRUs with directional antenna arrays, which may result in more beam pairs and hence number of classes for the AI/ML algorithms training. The reported WTRU position may be inaccurate due to location errors (e.g., GPS positioning errors) or in order to preserve user privacy. The location errors (e.g., GPS positioning errors) may be compensated for in the AI/ML (e.g., AIDEN) framework.

MDT based data may be sparse, for example in scenarios with low WTRU density or in small cells, where there may be less users as compared to macro cells. Techniques for data enrichment may be incorporated into the existing framework to obtain sufficient amount of training data. Accuracy may be limited by the large number of classes (e.g., 48 classes). AI/ML techniques that can handle classification of a large number of classes in comparison to the available data may be developed. AI/ML (e.g., AIDEN) frameworks may be tested in other 3GPP-defined environment scenarios with multiple frequency bands operating simultaneously. AI/ML (e.g., AIDEN) frameworks may be extended to scenarios with WTRU transitional mobility (e.g., instead of initial cell discovery).

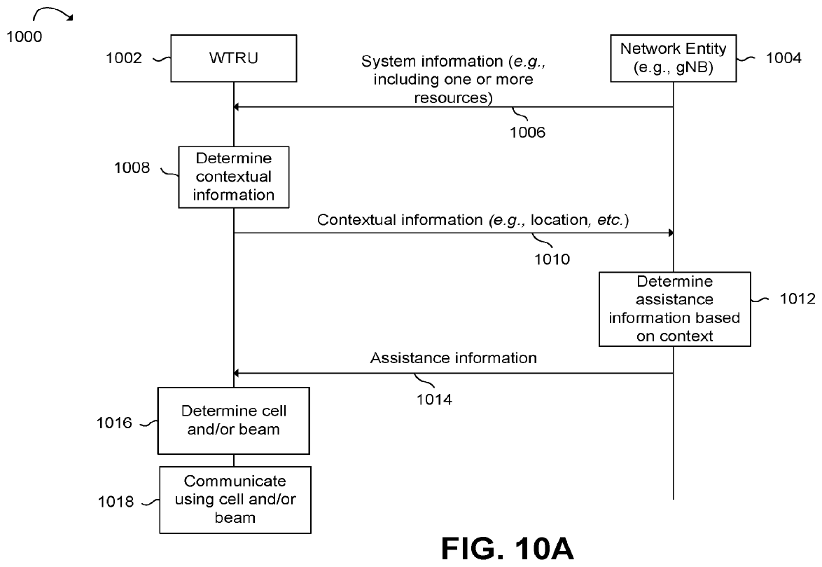

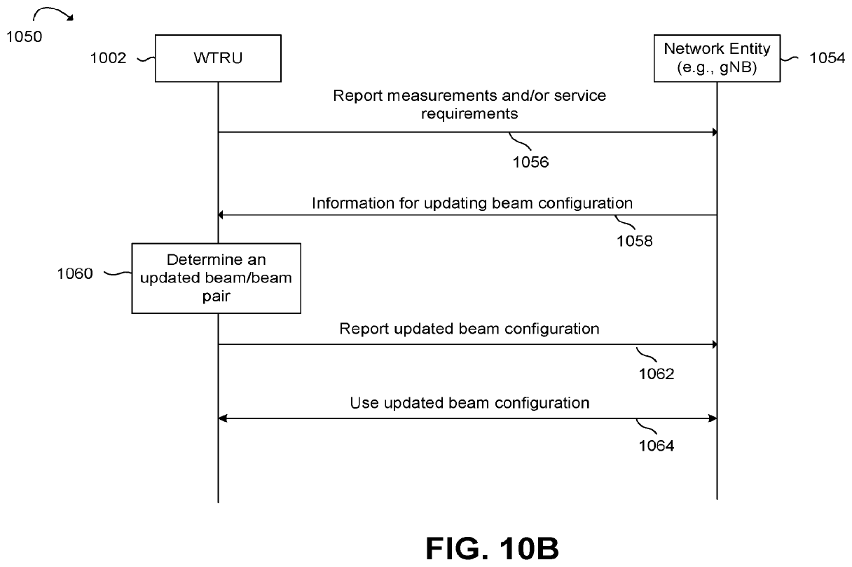

FIG. 10A illustrates a system flow diagram depicting an example of a communication procedure 1000 for cell selection and/or beam association. The communication procedure 1000 may be performed between one or more network entities. For example, the communication procedure 1000 may be performed between one or more WTRUs and one or more network entities (e.g., gNBs, BSs, network servers, etc.). Where the network entity is a gNB, the gNBs may be in communication with other network entities, such as network servers, for providing information to the WTRUs, as described herein.

At 1006, for example, the WTRU 1002 may receive system information (e.g., SIB) from a network entity 1004. The system information may include one or more resource(s) on which to report the location of the WTRU 1002. The system information may include one or more resources for the WTRU to communicate its location to the network entity 1004. The system information may include an indication of one or more channels or subchannels. The WTRU 1002 may determine UL resources on which to transmit its location from the DL transmission 1006 in which the system information is provided and a DL-Tx beam combination. The WTRU 1002 may detect a broadcasted transmission providing resources on which to transmit its location.

At 1008, the WTRU may determine contextual information for being reported to the network entity 1004. For example, the WTRU may determine its location mobility (e.g., speed or direction), antenna configuration, and/or service requirements. The WTRU 1002 may determine its location based on the system information received (e.g., system information received at 1006). The WTRU 1002 may determine its location relative to one or more cell(s) or DL-Tx beam(s) and/or beam-pair(s), as described herein. The location of the WTRU may include geographical location information, geographical coordinates (e.g., x and/or y geographical coordinates), GNSS location, GPS location/GPS coordinates, measurement(s) performed on one or more signals (e.g., signal(s) configured to enable WTRU location determination), and/or location information with respect to being within a given area and/or area index (e.g., to the gNB). The WTRU may generate a location report for transmitting its location, as described herein. For example, the WTRU 1002 may be configured with one or more areas. The WTRU 1002 may determine its location as being within an area. The WTRU 1002 may transmit an area and/or an area index to the network entity 1004.

At 1010, the WTRU may transmit the contextual information determined at 1008. For example, the WTRU 1002 may transmit its location to the network entity 1004 on the one or more resource(s) received from the network entity 1004. The WTRU 1002 may be triggered to report its location. The WTRU 1002 may be triggered to report its location when the WTRU 1002 detects a new cell or DL-Tx beam or combination thereof, as described herein. The WTRU 1002 may transmit its location in a location report. The location report may include one or more of: coordinates, area or area index and/or measurement(s) performed on one or more signals (e.g., signal(s) configured to enable WTRU 1002 location determination). The one or more measurements in the location report may be based on measurements on resources from one or more neighboring cell(s) and/or a serving cell. The WTRU 1002 may report its location by transmitting a signal in a resource, as described herein.

At 1012, the network entity 1004 may determine assistance information for being transmitted to the WTRU 1002 based on the contextual information it received from the WTRU 1002. For example, the network entity may determine a preferred cell (or set of cells) of a BS and/or at least one beam of a beam pair associated with a base station based on the location of the WTRU. The cell and/or at least one beam may be determined to be the best cell and/or at least one beam based on the location of the WTRU 1002. The assistance information may indicate the base station and/or cell (or set of cells) determined from the location of the WTRU 1002. The assistance information may also, or alternatively, indicate the at least one beam of the beam pair determined from the location of the WTRU 1002. The at least one beam may be a DL-Tx beam to which the WTRU 1002 may be associated.

The assistance information may include a defined subset of measurement resources for the cell and/or at least one beam in a beam pair based on the WTRU's 1002 location. For example, the assistance information may include one or more of the following: one or more measurement objects; a set of resources to monitor for a discovery signal or a synchronization signal block (SSB); and/or a mini measurement gap configuration. The subset of measurement resources may include a reference signal (RS) configuration associated with the cell/beam. The subset of measurement resources may include other measurement resources, as described herein.

The network entity 1004 may use AI/ML to identify the cell (or set of cells) of a BS and/or at least one beam in a beam pair based on the WTRU's 1002 location. The network entity 1004 may use AI/ML to the define the subset of measurement resources to be transmitted to the WTRU 1002. In other embodiments the subset of measurement resources, the cell, and/or the at least one beam in the beam pair may be predefined based on the location of the WTRU.

At 1014, the WTRU 1002 may receive the assistance information. At 1016, the WTRU 1002 may determine a cell of a BS and/or at least one beam of a beam pair with which to be associated for performing transmission based on the assistance information. For example, the WTRU 1002 may identify the BS (cell or cells) and/or at least one beam of the beam pair from the assistance information. The WTRU 1002 may perform measurements on one or more measurement resources indicated in the assistance information to identify the BS (cell or cells) and/or at least one beam of the beam pair, as described herein. The one or more measurements may include an exhaustive sweep. The measurements may include one or more of the following: RSRP, RSSI, RSRQ, SINR, RI, CQI, PMI, LI, CRI, Doppler shift, Doppler spread, angle of arrival of AoA, angle of departure of AoD, delay spread, and/or average delay. At 1018, the WTRU 1002 may perform communications on the cell (or cells) to the BS using the at least one beam of the beam pair. For example, the WTRU 1002 may perform random access (RA) or a first a transmission on the cell (or cells) to the BS using the at least one beam of the beam pair. The WTRU 1002 may transmit on the UL-Tx beam corresponding to an identified serving DL-Tx beam of the BS.

FIG. 10B depicts a flowchart illustrating an example of a communication procedure 1050 for updating the configuration for the cell (or cells) and/or beams (e.g., beam-pair) utilized by one or more WTRUs 1002. One or more portions of the procedure 1050 may be performed by one or more WTRUs 1002 and/or one or more network entities 1054. The network entities 1054 may be the same or different than the network entity 1004 shown in FIG. 10A. For example, the one or more network entities 1054 may include gNBs, BSs, network servers, and/or another network entity. Where the network entity is a gNB, the gNBs may be in communication with other network entities, such as network servers, for providing information to the WTRUs, as described herein.

The procedure 1050 may be performed as a second phase of the procedure 1000. Though the procedures 1000, 1050, and/or one or more portions therein, may be performed independently.

As shown in FIG. 10B, a WTRU 1002 may perform refined beam selection. In an example, the WTRU 1002 may be configured to and/or perform communication on a cell and a DL-Tx widebeam and may be triggered to perform refined beam selection to narrow the serving DL-Tx beam. A trigger may include a change in one or more service requirement(s). A trigger may be based on one or more measurement(s) (e.g., of interference and the like). A trigger may be based on performance of one or more transmission(s) (e.g., if the block error ratio (BLER) is higher than required). In another example, the WTRU 1002 may be configured to and/or perform communication on a cell and a DL-Tx narrowbeam and may be triggered (e.g., as described herein, based on mobility within the cell, etc.) to perform refined beam selection to widen the serving DL-Tx beam.

At 1056, the WTRU 1002 may send/report measurements and/or service requirements to the network entity 1054 (e.g., BS, gNB, etc.). The measurements may include one or more of the following: RSRP, RSSI, RSRQ, SINR, RI, CQI, PMI, LI, CRI, Doppler shift, Doppler spread, angle of arrival (AoA), angle of departure (AoD), delay spread, and/or average delay. As described herein, the network entity 1054 may be the BS of the cell identified during the procedure 1000 shown in FIG. 10A, or may be another network entity. The WTRU 1002 may send the one or more measurement(s) and/or service requirement(s) via one or more of the beams of the beam pair for communicating with the network entity 1054. For example, the WTRU 1002 may send the one or more measurements and/or service requirements via the UL-Tx beam of the WTRU 1002 corresponding to the DL-Tx beam of the network entity 1054. The WTRU 1002 may indicate service requirements to the network 1004, as described herein. The WTRU 1002 may indicate to the network entity 1054 whether the WTRU 1002 may be served by a narrow beam or a widebeam. The WTRU 1002 may be configured to communicate via a cell and DL-Tx widebeam (e.g., as determined by the procedure 1000, or portions thereof) and/or may begin operation based on the configuration. The WTRU 1002 may be triggered to perform refined beam selection, for example, to narrow the serving DL-Tx beam when the WTRU 1002 is capable.

At 1058, the network entity 1004 may send the WTRU 1002 information for updating the beam configuration. For example, the information for updating the beam configuration may include a defined subset of measurement resources that may be used by the WTRU 1004 when performing an exhaustive search to identify a narrower beam from which DL information may be received on the DL-Tx beam from the network entity 1054. The defined subset of resources may include a cell identifier and/or a set of reference signals for measuring each of the possible finer beams during the exhaustive search. In another example, the network entity 1054 may determine the one of a cell and/or an updated beam/beam pair based on the reported measurements and/or service requirements and explicitly indicate the cell and/or the updated beam/beam pair in the communication 1058 to the WTRU 1002. For example, the network entity 1054 may implement AI/ML and/or another refinement algorithm to determine the cell and/or refined beam/beam pair based on the measurements or service requirements. In another example, the cell and/or beam/beam pair may be predefined in information stored at the network entity 1054 based on ranges of measurements that are reported.

At 1060, the WTRU 1002 may determine an updated beam/beam pair based on the information received from the network entity 1054. The updated beam/beam pair may be narrower than the previous beam/beam pair. The updated beam/beam pair may be explicit in the information or the WTRU 1002 may perform measurements for determining the updated beam/beam pair at 1060 based on the received information. For example, the WTRU 1002 may perform measurements on the set of reference signals received in the information from the network entity 1054 during an exhaustive search. The WTRU 1002 may also determine an updated cell for performing communication based on the information received from the network entity 1054.

At 1062, the WTRU 1002 may report at least one of the measurements performed, the cell and/or updated beam/beam-pair to the network entity 1054. The WTRU 1002 may be configured with resources on which to report the cell and/or updated beam/beam-pair to the network entity 1054, as described herein. The WTRU 1002 may report the appropriate values within a wider or narrower beam. Appropriate values may include one or more measurements, as described herein. At 1064, the WTRU 1002 may perform communications with the network entity 1054 using the updated beam configuration.

The processes and instrumentalities described herein may apply in any combination, may apply to other wireless technologies, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1. A method performed at a wireless transmit/receive unit (WTRU), the method comprising:
receiving an indication of a resource on which to report a location of the WTRU;
transmitting an indication of the location using the resource;
receiving, in response to the transmission of the location using the resource, an indication of a first subset of a plurality of measurement resources for enabling beam association on a first subset of a plurality of beam pairs (BPs);
determining, based on first measurements performed on the first subset of the plurality of measurement resources, a first beam pair (BP) of the first subset of the plurality of BPs;
reporting the first measurements and a service requirement via the first BP to trigger refinement of the beam association;
receiving, in response to reporting the first measurements and the service requirement, an indication of a second subset of the plurality of measurement resources for enabling refined beam association on a second subset of the plurality of BPs;
determining, based on second measurements performed on the second subset of the plurality of measurement resources, a second BP of the second subset of the plurality of BPs; and
performing a transmission using the second BP.

2. The method of claim 1, wherein the second BP has a beam width that is narrower than a beam width of the first BP.

3. The method of claim 2, further comprising:
in response to the second measurements performed on the second subset of the plurality of measurement resources, reporting one or more of the first measurements or one or more of the second measurements to a base station (BS) for receiving on a narrower downlink (DL) transmit beam of the second BP than a DL transmit beam of the first BP.

4. The method of claim 3, further comprising:
performing a search based on the second subset of the plurality of measurement resources to refine the first BP or to determine the narrower DL transmit beam of the second BP.

5. The method of claim 2, wherein the first BP is a widebeam BP, and wherein the second BP is a narrowbeam BP.

6. The method of claim 1, wherein the first subset of the plurality of measurement resources comprises one or more measurement objects, a set of resources to monitor for a discovery signal or a synchronization signal block (SSB), or a mini measurement gap configuration.

7. The method of claim 1, wherein the indication of the first subset of the plurality of measurement resources is received via a radio resource control (RRC) message or a medium access control (MAC) control element.

8. The method of claim 1, further comprising:
performing a neighbor cell discovery using the first subset of the plurality of measurement resources; and
reporting, via an uplink (UL) resource, neighbor cell measurement resources or the neighbor cell discovery.

9. The method of claim 1, further comprising:
determining a preferred cell or a preferred at least one beam of a BP; and
reporting the preferred cell or a preferred at least one beam of a BP.

10. The method of claim 1, further comprising:
determining to trigger refinement of the first subset of the plurality of BPs based on the service requirements, wherein the service requirements include at least one of an amount of data, a reliability requirement, a latency requirement, or a data type.

11. A wireless transmit receive unit (WTRU) comprising:
a processor configured to:
receive an indication of a resource on which to report a location of the WTRU;
transmit an indication of the location using the resource;
receive, in response to the transmission of the location using the resource, an indication of a first subset of a plurality of measurement resources for enabling beam association on a first subset of a plurality of beam pairs (BPs);
determine, based on first measurements performed on the first subset of the plurality of measurement resources, a first beam pair (BP) of the first subset of the plurality of BPs;
report the first measurements and a service requirement via the first BP to trigger refinement of the beam association;
receive, in response to reporting the first measurements and the service requirement, an indication of a second subset of the plurality of measurement resources for enabling refined beam association on a second subset of the plurality of BPs;
determine, based on second measurements performed on the second subset of the plurality of measurement resources, a second BP of the second subset of the plurality of BPs; and
perform a transmission using the second BP.

12. The WTRU of claim 11, wherein the second BP for the BS having second BP has a beam width that is narrower than a beam width of the first BP.

13. The WTRU of claim 12, wherein the processor is further configured to:
in response to the second measurements performed on the second subset of the plurality of measurement resources, report one or more of the first measurements or one or more of the second measurements to a base station (BS) for receiving on a narrower downlink (DL) transmit beam of the second BP than a DL transmit beam of the first BP.

14. The WTRU of claim 13, wherein the processor is further configured to:
perform a search based on the second subset of the plurality of measurement resources to refine the first BP or to determine the narrower DL transmit beam of the second BP.

15. (canceled)

16. (canceled)

17. (canceled)

18. (canceled)

19. The WTRU of claim 11, wherein the processor is further configured to:
determine a preferred cell or a preferred at least one beam of a BP; and
report the preferred cell or a preferred at least one beam of a BP.

20. The WTRU of claim 11, wherein the processor is further configured to trigger refinement of the first subset of the plurality of BPs based on the service requirements, wherein the service requirements include at least one of an amount of data, a reliability requirement, a latency requirement, or a data type.

21. The method of claim 1, wherein each BP of the plurality of BPs is associated with a corresponding base station (BS), wherein the first BP is associated with a first BS, and wherein the second BP is associated with the first BS.

22. The method of claim 1, wherein each BP of the plurality of BPs is associated with a corresponding base station (BS), wherein the first BP is associated with a first BS, and wherein the second BP is associated with a second BS that is different than the first BS.

23. The WTRU of claim 11, wherein each BP of the plurality of BPs is associated with a corresponding base station (BS), wherein the first BP is associated with a first BS, and wherein the second BP is associated with the first BS.

24. The WTRU of claim 11, wherein each BP of the plurality of BPs is associated with a corresponding base station (BS), wherein the first BP is associated with a first BS, and wherein the second BP is associated with a second BS different than the first BS.
